(19) United States
(12) Patent Application Publication
(10) Pub. No.: US 2004/0035039 A1
(43) Pub. Date: Feb. 26, 2004

(54) Display box for a picture and an E-Z Pass unit

(75) Inventor: Laszlo Bilinszky, Hopelawn, NJ (US)

Correspondence Address: EZRA SUTTON, P.A., PLAZA 9, 900 ROUTE 9, WOODBRIDGE, NJ, 07095, US

(73) Assignee: Bruce Ciallella

(21) Appl. No.: 10/226,080

(22) Filed: Aug. 22, 2002

(51) Int. Cl. A47G 1/06; G09F 21/04; A47G 1/17

(52) U.S. Cl. 40/722; 40/760; 40/593

(57) ABSTRACT

A display box for displaying a photograph and holding an E-Z Pass unit therein and attaching it to a windshield of a vehicle. The display box includes an open side for receiving the photograph and the E-Z Pass unit; a front panel having an open window for displaying the photograph; and a back panel having two spaced-apart openings for receiving therethrough attachment strips of the E-Z Pass unit for removably attaching the display box to the windshield of a vehicle.

### FIELD OF THE INVENTION

The present invention relates to a display box for displaying a photograph or document, and more particularly, to a new and improved display box or display container for holding an E-Z Pass unit therein and for also displaying a photograph or document, which is adapted to be affixed to the windshield of a motor vehicle.

### BACKGROUND OF THE INVENTION

With the advent and operational use of the E-Z Pass unit in various states in the U.S. for paying tolls on interstate roads, the E-Z Pass unit has become a standard fixture on the windshields of motor vehicles. Most drivers find the E-Z Pass unit to be an eyesore with respect to the vehicle. There remains a need for a display box which will cover or enclose the E-Z Pass unit and provide an area to display a favorite photograph to the driver of the motor vehicle. The display box would readily accommodate both the photograph and the E-Z Pass unit within the interior of the display box, and be readily attached to the windshield of the vehicle or on the dashboard of the vehicle.

### DESCRIPTION OF THE PRIOR ART

A number of prior art patents disclose the concept of display boxes for displaying photographs or other documents. They include U.S. Pat. Nos. 4,184,276; 4,479,318; 4,695,077; 5,502,912; and 5,913,541.

Accordingly, it is an object of the present invention to provide a display box for both displaying a photograph and for holding of an E-Z Pass unit therein, or other documents therein.

Another object of the present invention is to provide a display box that is removably attached to an inner surface of a windshield of a vehicle using Velcro™ attachment strips.

Another object of the present invention is to provide a display box that is sized to accommodate various sized photographs and documents

### SUMMARY OF THE INVENTION

In accordance with the present invention, there is provided a display box for displaying a photograph and holding an E-Z Pass unit on a windshield of a vehicle. The display box includes an open side for inserting and receiving the photograph and the E-Z Pass unit, a front panel having an open window for displaying the photograph, and a back panel having two spaced-apart openings for receiving therethrough attachment strips of the E-Z Pass unit for removably attaching the display box to the windshield of a vehicle.

### BRIEF DESCRIPTION OF DRAWINGS

Further objects, features, and advantages of the present invention will become apparent upon the consideration of the following detailed description of the presently-preferred embodiment when taken in conjunction with the accompanying drawings, wherein:

FIG. 1 is a front perspective view of a display box of the preferred embodiment of the present invention showing a front window opening for receiving a photograph;

FIG. 2 is a rear perspective view of the display box showing a cover flap in an opened position for receiving a photograph and an E-Z Pass unit within a top side opening of the display box;

FIG. 3 is a top plan view of a cardboard blank and its foldable flaps for forming the display box;

FIG. 4 is a side view of the display box showing the hook and loop fastener attachment strips being attached to the hook and loop fastener attachment strips on a windshield of a vehicle;

FIG. 5 is a side view of the display box showing double-sided adhesive strips on the windshield of the vehicle;

FIG. 6 is a front elevational view of the display box showing the assembled display box attached to an inner surface of the windshield being viewed from inside the vehicle;

FIG. 7 is a perspective view of an alternate embodiment of the present invention showing the display box formed of cardboard for receiving a 3″×5″ photograph; and

FIG. 8 is a front perspective view of an alternate embodiment of the present invention showing the display box formed of plastic.

### DETAILED DESCRIPTION OF THE PREFERRED EMBODIMENT

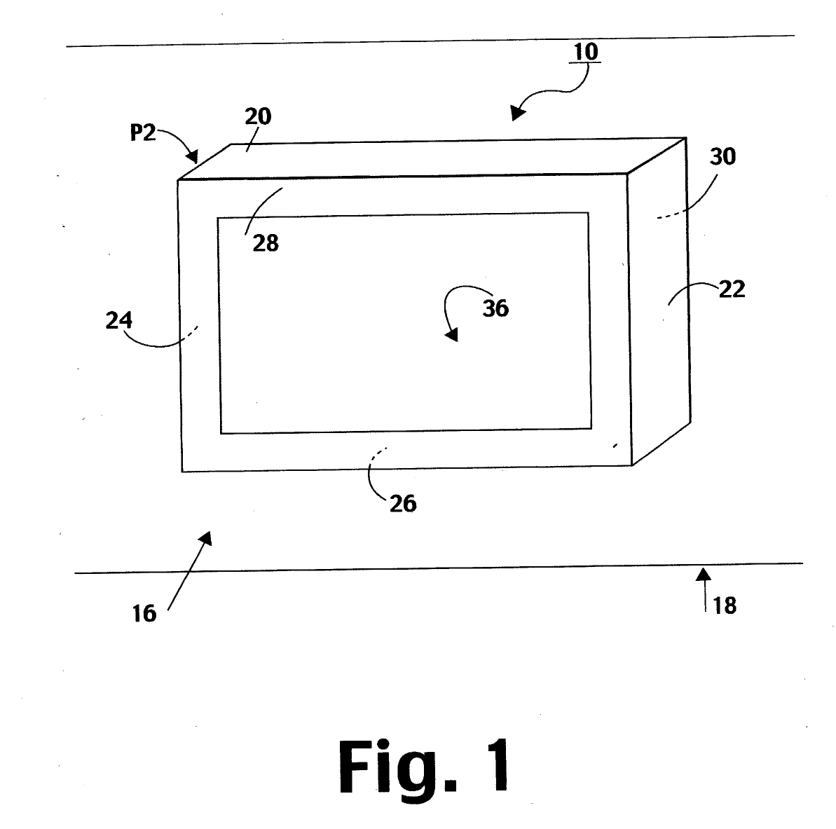

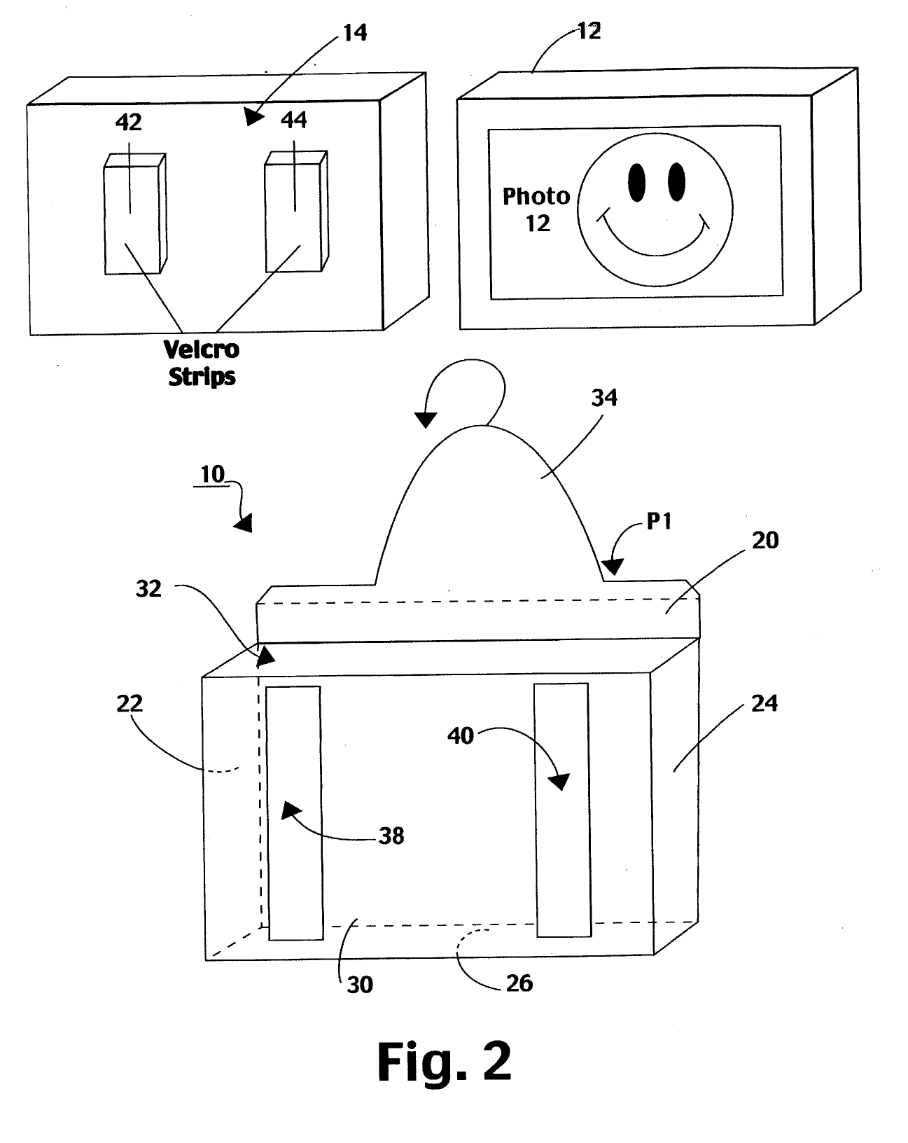

A display box 10 of the preferred embodiment of the present invention is represented in detail by FIGS. 1 through 7 of the patent drawings. The display box 10, as shown in FIGS. 1 and 2, is used for displaying a photograph 12 and for holding an E-Z Pass unit 14 and which is attached to a windshield 16 of a vehicle 18. The display box 10 includes a top panel 20, closed side panels 22, 24 and 26, a front panel 28 and a back panel 30.

The top panel 20 when in an opened position P₁ includes a top side opening 32 for receiving the picture/photograph 12 and the E-Z Pass unit 14 therein. The top opening 32 may be closed with a cover flap 34, as shown in FIG. 2. The cover flap 34 is inserted within the top side opening 32 or placed on the outside surface 31 of back panel 30 to close the top panel 20 to closed position P₂, as shown in FIG. 1, after the inserting of the photograph 12 and the E-Z Pass unit 14 through top side opening 32.

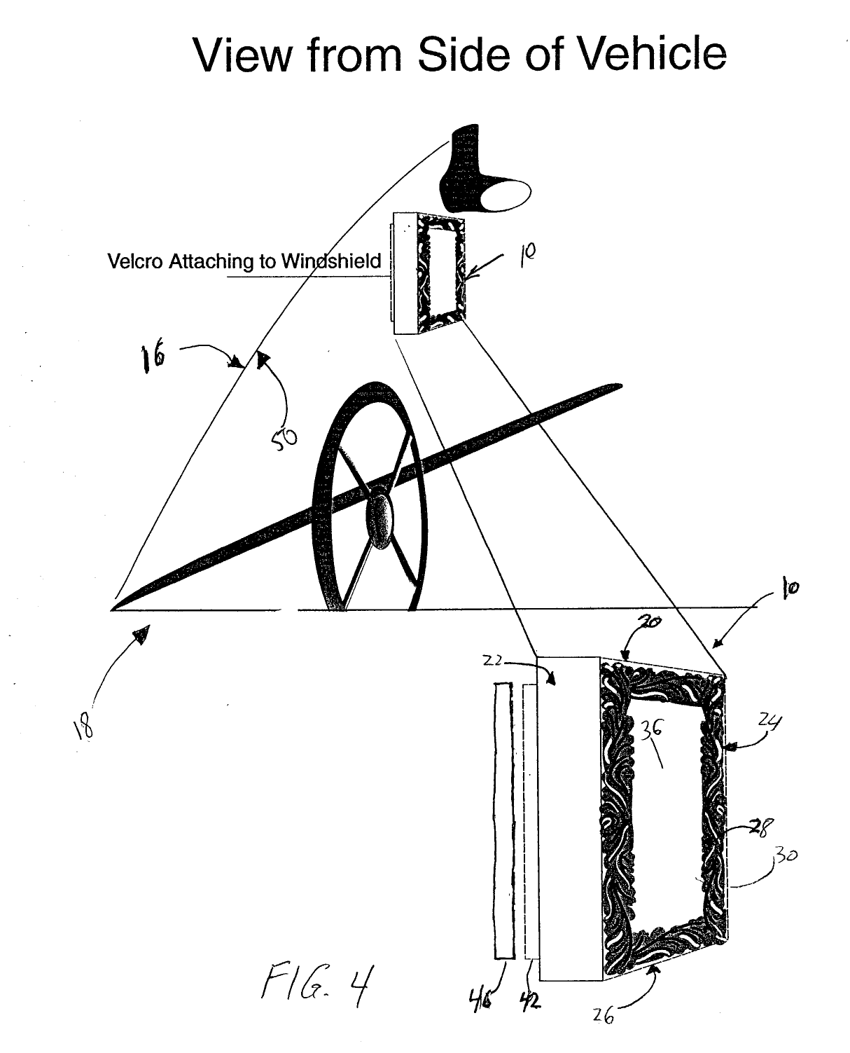

The front panel 28, as shown in FIG. 1, includes an open window 36 for displaying a photograph 12 or other documents such as a vehicle registration, vehicle insurance and the like. In addition, other documents may be stored in display box 10. The back panel 30, as shown in FIG. 2, includes two spaced-apart openings 38 and 40 for receiving through the openings 38, 40 Velcro™ attachment strips 42, 44 (hook and loop fastener attachment strips), respectively, of the E-Z Pass unit 14. As shown in FIG. 4, the Velcro™ strips 42, 44 matingly engage another set of Velcro™ attachment strips 46, 48 (hook and loop fastener attachment strips) which are mounted on the inner surface 50 of the vehicle windshield 16 for releasably mounting the display box 10 on windshield 16 of the vehicle 18. Alternatively, it may be mounted on the dashboard 19 of the vehicle.

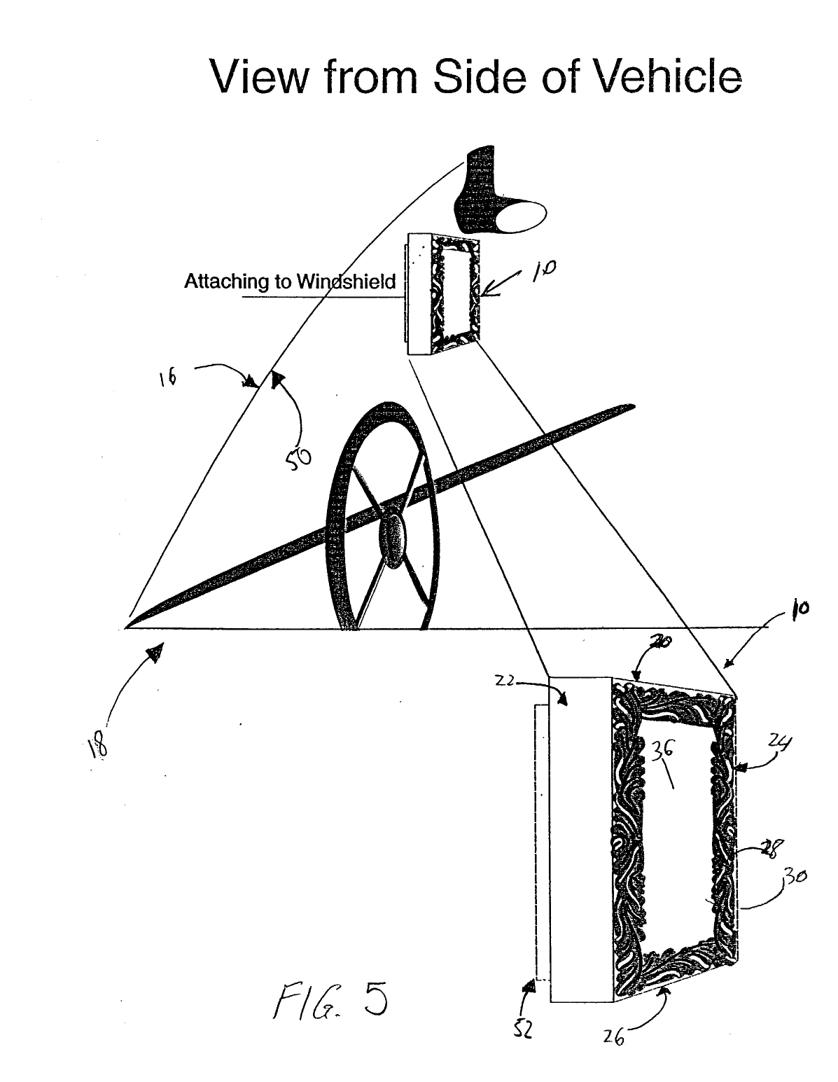

Alternatively, Velcro™ strips 40, 42, 44 and 46 may be replaced with double-sided adhesive strips 52, 54 as shown in FIG. 5 of the drawings, or may be replaced with suction cups, and other known attachment devices or mounting devices.

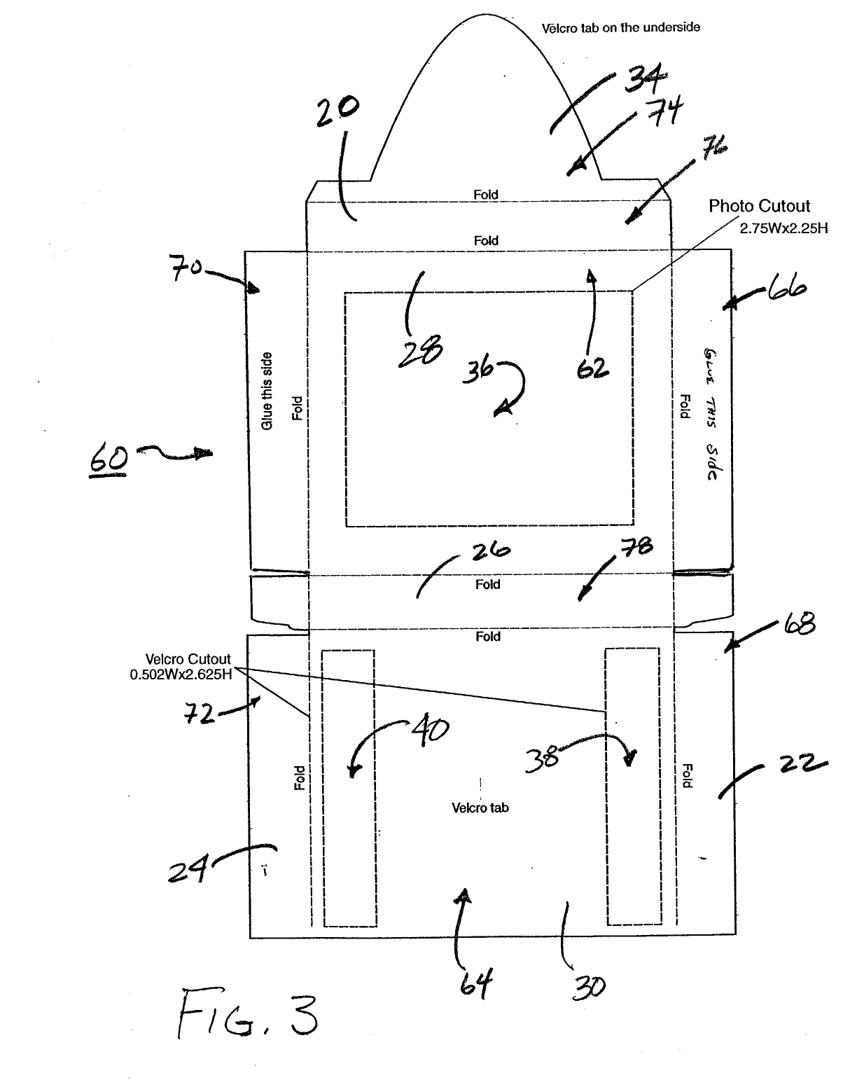

As shown in FIG. 3, display box 10 is formed from a cardboard or paperboard blank 60 having a panel 62 for forming the front panel 28, a panel 64 for forming the back panel 30, a first set of side flaps 66, 68 for forming side panel 22, a second set of side flaps 70, 72 for forming side panel 24, an upper set of side flaps 74, 76 for forming a cover flap 34 and top panel 20 and a scored center section 78 for forming a bottom panel 26.

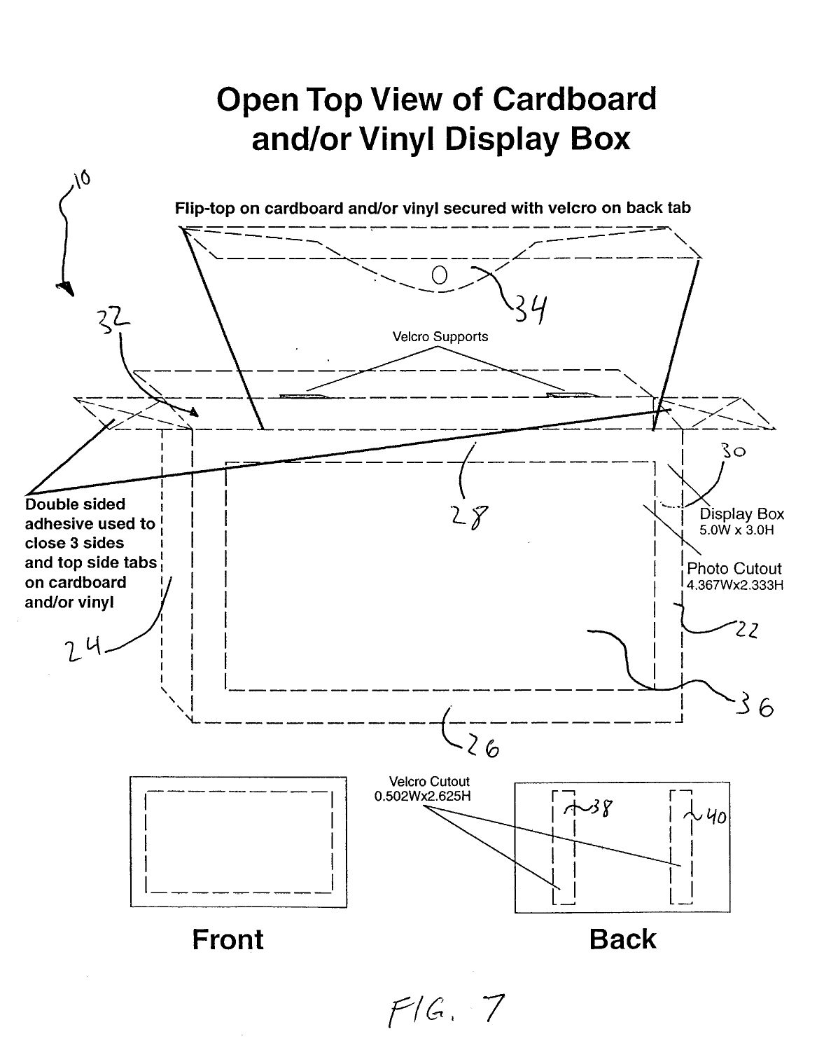

Another embodiment of the display box 10, as shown in FIG. 7, may be made of cardboard or vinyl materials and the top cover 80 may be folded.

Also, as shown in FIG. 7, the width of the display box 10 may be made wider to accommodate a 3 inch by 5 inch photograph.

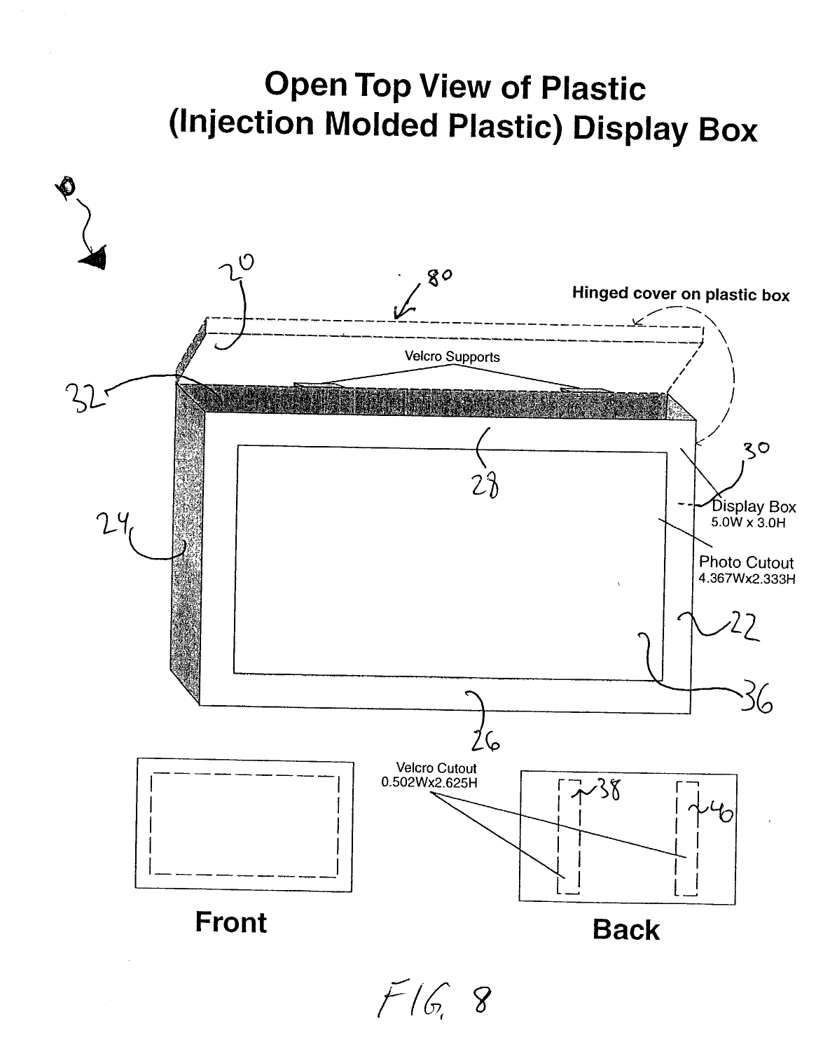

As shown in FIG. 8, another embodiment of the display box 10 may be made of moldable plastic material and the top cover 80 may be hinged, folded or snap-fitted. Alternatively, the top side opening 32 may have no cover for the easy insertion of the photograph 12 and E-Z Pass unit 14 therein, or other documents being stored therein.

It should be understood that the term display box as used herein is not limiting and is intended to include a display container of any shape or size, with or without a cover.

### Operation of the Present Invention

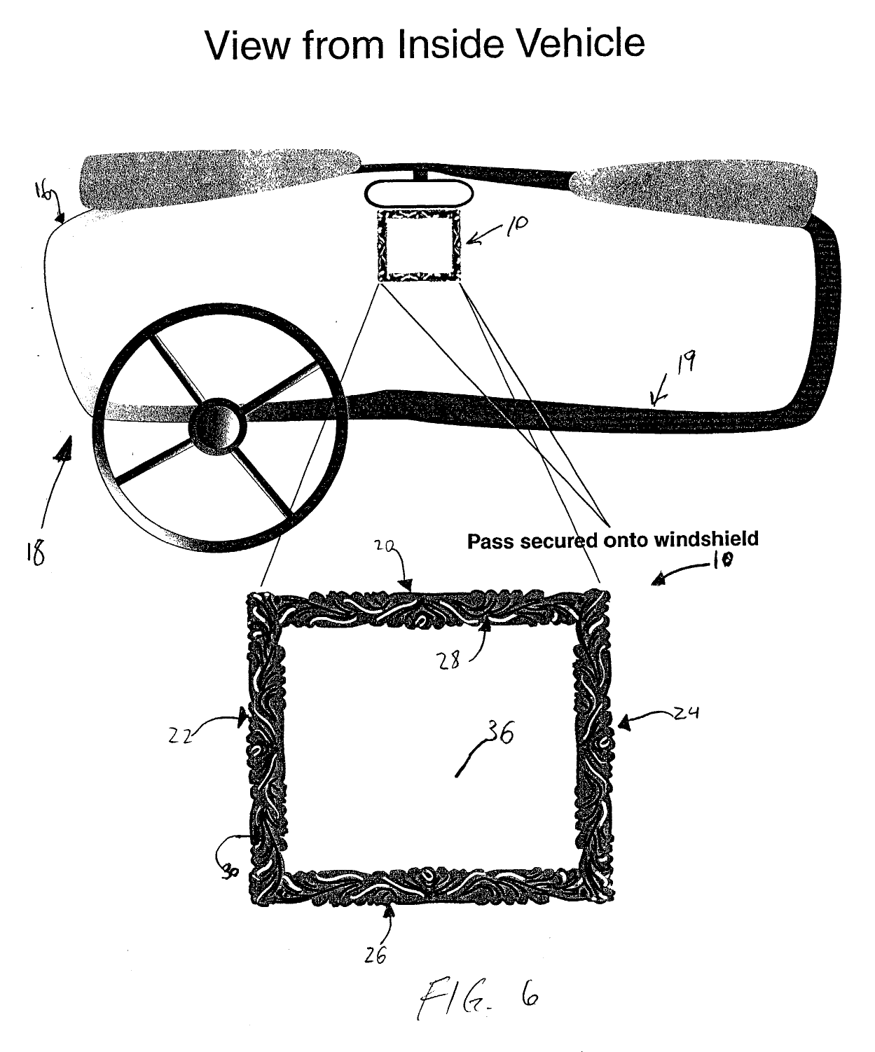

In operation, the display box 10 operates in the following manner, as shown in FIGS. 2, 4 to 7. As shown in FIG. 2, the user simply inserts the desired photograph 12 through the top side opening 32 and places the photograph 12 adjacent to the window opening 36 of the front panel 28 to be displayed. The user then inserts the E-Z Pass unit 14 through the top side opening 32 and places the Velcro™ attachment strips 42, 44 to extend through openings 38, 40, respectively. Other documents may also be stored in dsplay box 10. The user then attaches the Velcro™ attachment strips 42, 44 to another set of Velcro™ attachment strips 46, 48 (already mounted on the inner surface 50 of the vehicle's windshield 16) in order to mount the display box 10 to the inner surface 50 of the windshield 16, as shown in FIGS. 4, 6 & 7 of the drawings.

### Advantages of the Present Invention

Accordingly, an advantage of the present invention is that it provides for a display box for both displaying a photograph and for holding of an E-Z Pass unit therein, or other documents therein.

Another advantage of the present invention is that it provides for a display box that permits removable attachment to an inner surface of a windshield of a vehicle using Velcro™ attachment strips.

A further advantage of the present invention is that it provides for a display box that is sized to accommodate various sized photographs and documents.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A display box for displaying a photograph and holding an E-Z Pass unit, comprising:
a) an open side for receiving the photograph and the E-Z Pass unit;
b) a front panel having an open window for displaying the photograph; and
c) a back panel having two spaced-apart openings for receiving therethrough attachment strips of the E-Z Pass unit for removably attaching said display box to the windshield or dashboard of a vehicle.

2. A display box in accordance with claim 1, wherein said attachment strips are hook and loop fastener strips.

3. A display box in accordance with claim 1, wherein said attachment strips are double-sided adhesive strips.

4. A display box in accordance with claim 1, wherein said display box is made from a paperboard blank.

5. A display box in accordance with claim 1, wherein said display box is made from a cardboard blank.

6. A display box in accordance with claim 1, wherein said display box is made from moldable plastic materials.

7. A display box in accordance with claim 1, wherein said display box is made from vinyl materials.

8. A display box in accordance with claim 1, wherein said display box further includes a cover for covering said open side.

9. A display box in accordance with claim 8, wherein said cover is foldable, hinged or snap-fitted.

10. A display box for displaying a photograph and for holding a toll-paying unit and documents, comprising:
a) an open top for inserting the photograph, the toll-paying unit and the documents into said display box;
b) a front panel having an opening for displaying the photograph; and
c) a back panel having at least one opening for receiving therethrough an attachment strip of a toll-paying unit for removably attaching said display box to the windshield or dashboard of a vehicle.
